(19) United States
(12) Patent Application Publication
(10) Pub. No.: US 2020/0164762 A1
(43) Pub. Date: May 28, 2020

(54) Method of Achieving an Optimal Operating Point in Battery Swapping Process

(71) Applicants: Robert Bosch GmbH, Stuttgart (DE); Robert Bosch Engineering and Business Solutions Private Limited, Karnataka (IN)

(72) Inventors: Murali Vidhya, Karnataka (IN); Abhik Banerjee, Kolkata (IN); Gopalan Venkoparao Vijendran, Bangalore (IN)

(21) Appl. No.: 16/539,259

(22) Filed: Aug. 13, 2019

(30) Foreign Application Priority Data
Nov. 27, 2018 (IN) 201841044609

(51) Int. Cl. B60L 58/12; H01M 10/48; H01M 10/42; B60L 53/80; B60L 53/66

(52) U.S. Cl. CPC B60L 58/12; H01M 10/48; H01M 10/4257; H01M 2220/20; B60L 53/66; H01M 2010/4278; B60L 53/80

(57) ABSTRACT

A method of achieving an optimal operation point for swapping a battery in an electric vehicle includes sensing a battery voltage level in the electric vehicle when the electric vehicle is in a functional mode and determining a distance that the electric vehicle can travel based on the sensed battery voltage level. The method further includes detecting at least one battery swapping center in a predefined distance, when the battery voltage level is below a threshold value. The method further includes providing the at least one battery-swapping center information regarding the detected battery voltage level of the electric vehicle for swapping of the battery of the electric vehicle.

### FIELD OF THE INVENTION

This invention relates to the field of a method of swapping a battery in an electric vehicle. The invention further relates in achieving an efficient anti optimal operational point of swapping process through a learning technique.

### BACKGROUND OF THE INVENTION

Battery swapping of electric vehicles has been touted as a solution that can help address some of the key hurdles to mass adoption of electric vehicles. However, given the vast number of industry players dealing with manufacturing and retailing of both vehicles and batteries, the success of battery swapping hinges on the sustainability of an ecosystem in which multiple stakeholders can participate to achieve sustainable regions of operational conditions.

Prior art patent application US 20120248868 discloses a battery car employed in conjunction with a battery car station employs a swappable battery configuration. Access to the batteries of differing types is controlled through a switch control processor selectively coupling batteries tc one or more power grids depending upon a given battery's sensed energy. Access to the batteries of differing types is based on demands of vehicle operation. Based on such configuration, a swappable battery car station in communication with the battery car might then selectively replace batteries as needed.

### BRIEF DESCRIPTION OF THE ACCOMPANYING DRAWING

Different modes of the invention are disclosed in detail in the description and illustrated in the accompanying drawing:

FIG. 1 illustrates a system for battery swapping in an electric vehicle in accordance to one embodiment of the invention; and

FIG. 2 illustrates a flow chart of a method of swapping battery in an electric vehicle.

### DETAILED DESCRIPTION OF THE EMBODIMENTS

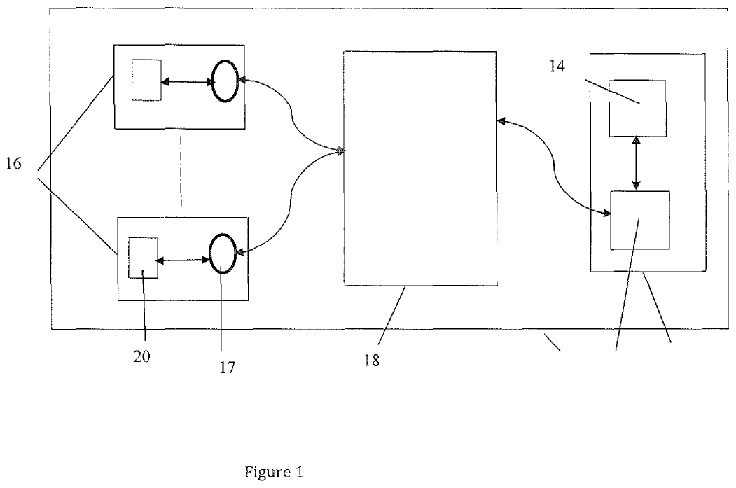

FIG. 1 illustrates a control unit 13 in an electric vehicle 12 according to one embodiment of the invention. The control unit 13 adapted to sense a battery voltage level in an electric vehicle 12, when the electric vehicle 12 is in a functional mode and to determine a distance that the electric vehicle 12 could travel based on the sensed battery voltage level. The control unit 13 adapted to detect at least one battery-swapping center 16 in a predefined distance, when the battery voltage level is below a threshold value and to update at least one battery-swapping center 16 regarding the detected battery voltage level of the electric vehicle 12 for swap of a battery 14 of the electric vehicle 12.

Further the construction of a system 10 comprising the control unit 13 and the components of the system 10 is explained as follows. The control unit 13 adapted to determine an optimal operating point during the swapping of the battery 14 of the electric vehicle 12. The optimal operating point is a point where, the control unit 13 uses a maximum power of the electric vehicle battery 14 to cover/travel a maximum distance, when the electric vehicle 12 is in functional mode. The operating point is also a point where, at least one battery-swapping center 16 detects the request from the vehicle prior for swapping of the battery 14. At the operating point, the battery-swapping center 16 will have maximum requests from the electric vehicle 12 for multiple battery swaps. At least one characteristic of at least one battery-swapping center 16 is altered to achieve the optimal operating point based on a request transmitted from the control unit 13. The characteristics of the battery-swapping center 16 is chosen from a group of characteristics comprising optimal supply of fully charged batteries 20, capacity of the battery swapping center 16 to charge the battery 14 of the electric vehicle 12, cost of at least one battery swapping method or the like.

According to one embodiment of the invention, the system 10 comprises a cloud server/database 18 connected via a communication means, between at least one electric vehicle 12 and to multiple battery swapping centers 16, where the vehicle is traveling. The communication means is a wireless network like a Wi-Fi.

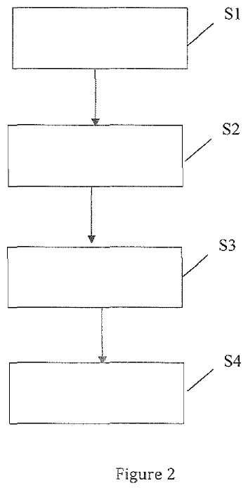

FIG. 2 illustrates a flow chart of a method of swapping a battery 14 in an electric vehicle 12. In step S1, a battery voltage level in the electric vehicle 12 is sensed, when the electric vehicle 12 is in a functional mode. In step S2, a distance is determined that the electric vehicle 12 could travel based or, the sensed battery voltage level. In step S3, at least one battery-swapping center 16 in a predefined distance is detected, when the battery voltage level is below a threshold value. In step S4, at least one battery-swapping center 16 is upgraded regarding the detected battery voltage level of the electric vehicle 12 for swap of a battery 14 of the electric vehicle 12.

The method of swapping a battery 14 in an electric vehicle 12 is explained in detail. The user of the electric vehicle 12 inputs an origin and a destination information into the vehicle 12. Based on the battery voltage level present in the electric vehicle 12, the control unit 13 determines the maximum distance that can be covered when the vehicle 12 is in operational mode. When the vehicle 12 starts the trip from the origin to the destination, the control unit 13 detects multiple battery-swapping centres 16 in a predefined distance range from the current location of the vehicle 12, upon detecting a minimum battery voltage in the battery of the vehicle 12. According to one embodiment of the invention, the control unit 13 of the electric vehicle 12 directly establishes the communication with the control unit of at least one battery-swapping centre 16. According to another embodiment of the invention, the control unit 13 transmits a request to the battery-swapping centres 16 via the cloud server 18, for the swap of the battery or to charge the battery 14. At least one battery-swapping centre 16, upon detecting the request from the control unit 13 of the vehicle 12, transmits/acknowledges the requirement based on the capacity of the batteries 20 available in the centre 16 or based on the availability to charge the battery 14 of the vehicle 12. The characteristics of the battery-swapping centre 16 as mentioned above is transmitted to the control unit 13 of the vehicle 12. Based on at least one characteristic of the battery-swapping centre 16, the control unit 13 initiates the process of the battery swapping, before reaching the battery-swapping centre 16.

The control unit 13 transmits the requirements comprising number of batteries 14 needed to be swapped, the time to charge the current batteries, cost of the batteries or the like. The control unit 17 present in at least one battery-swapping centre 16, receives the request for swapping of the battery 14 from the electric vehicle 12 and responds accordingly. The control unit 13 of the electric vehicle 12 and the control unit 17 of the battery-swapping centre 16 responds to each other requests, in such a way that, the optimal operating point where, both the swapping-centres 16 and the electric vehicles 14, will experience a maximum output in terms of efficiency. According to one embodiment of the invention, a learning technique like a multi-objective optimization technique (as known to a person skilled in the art) is applied to determine the optimal operating point.

With the above system 10 disclosed, determines the optimal operating regions for each participant (battery-swapping center 16 and the electric vehicle 14) based on at least one objective functions while ensuring sustainability of the system 10. For an individual vehicle, it determines the optimal choice of battery-swapping center 16 and swapping time in order to maximize distance per battery while ensuring continuous drive time. For an individual battery swapping station—efficient operation is through the maximum swap operations and minimum duration of charging and total charging load. The system 10 incorporates a multi-objective reinforcement-learning technique, which learns optimal configurations for each participant, for an individual battery-swapping center 16, it determines the optimal batteries 20 to charge to ensure optimal supply of fully charged batteries 20.

It should be understood that embodiments explained in the description above are only illustrative and do not limit the scope of this invention. Many such embodiments and other modifications and changes in the embodiment explained in the description are envisaged. The scope of the invention is only limited by the scope of the claims.

1. A method of achieving an optimal operation point for swapping a battery in an electric vehicle, comprising:
sensing a battery voltage level of the battery in the electric vehicle when the electric vehicle is in a functional mode;
determining a distance that the electric vehicle can travel based on the sensed battery voltage level;
detecting at least one battery swapping center in a predefined distance when the sensed battery voltage level is below a threshold value; and
transmitting to the at least one battery-swapping center information regarding the sensed battery voltage level for swap of the battery of the electric vehicle.

2. The method as claimed in claim 1, further comprising:
determining an optimal operating point to regulate the swapping of the battery of the electric vehicle.

3. The method as claimed in claim 2, further comprising:
utilizing a maximum voltage level of the battery voltage in the electric vehicle at the optimal operating point to cover a maximum distance when the electric vehicle is in the functional mode.

4. The method as claimed in claim 1, further comprising:
transmitting a request from the electric vehicle; and
receiving information regarding at least one characteristic of the detected at least one battery swapping center upon the transmission of the request.

5. The method as claimed claim 4, wherein the at least one characteristic of the at least one battery swapping center includes an optimal supply of fully charged batteries, a capacity of the battery swapping center to charge the battery of the electric vehicle, a cost of at least one battery swapping, or the like.

6. A control unit in an electric vehicle, comprising:
a communications device,
the control unit configured to:
sense a battery voltage level of a battery in an electric vehicle, when the electric vehicle is in a functional mode;
determine a distance that the electric vehicle can travel based on the sensed battery voltage level;
detect at least one battery swapping center in a predefined distance when the sensed battery voltage level is below a threshold valve; and
transmitting, using the communications device, to the at least one battery-swapping center information regarding the sensed battery voltage level for swap of the battery (14) of the electric vehicle.

7. The control unit as claimed in claim 6, wherein the control unit is further configured to:
determine an optimal operating point during the swapping of the battery of the electric vehicle.

8. The control unit as claimed in claim 7, wherein the control unit is further configured to:
transmit a request from the electrical vehicle;
receive information regarding a characteristic of the detected at least one battery swapping center upon the transmission of the request; and
alter the characteristic of the detected at least one battery-swapping center to achieve the optimal operating point.
